(19) United States
(12) Patent Application Publication
(10) Pub. No.: US 2024/0279576 A1
(43) Pub. Date: Aug. 22, 2024

(54) SOAP RECYCLING APPARATUS

(71) Applicant: Ernest Williams, Dallas, TX (US)

(72) Inventor: Ernest Williams, Dallas, TX (US)

(21) Appl. No.: 18/112,076

(22) Filed: Feb. 21, 2023

(51) Int. Cl. C11D 13/16; C11D 13/30; H05B 1/02

(52) U.S. Cl. CPC C11D 13/16; C11D 13/30; H05B 1/0252

(57) ABSTRACT

A soap recycling apparatus for reconstituting bar soap remnants into a new bar of soap includes a housing with a bottom wall, a top wall, and a perimeter wall, the perimeter wall being coupled to and extending between the bottom wall and the top wall. The housing defines an interior space bounded by each of the bottom wall, the top wall, and the perimeter wall. A mold is coupled to the top wall and extends downwardly into the interior space. The mold has an open top and is integral with the top wall of the housing. A heating element is coupled to the mold and is positioned in the interior space. The heating element is also positioned such that the heating element heats the mold when the heating element is activated.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to soap recycling apparatuses and more particularly pertains to a new soap recycling apparatus for reconstituting bar soap remnants into a new bar of soap.

### (2) Description of Related Art Including Information Disclosed Under 37 CFR 1.97 and 1.98

The prior art discloses myriad apparatuses for melting bar soap remnants for reconstituting into a new bar of soap by forming in a mold. Many of these apparatuses pour the melted soap into a separate mold for forming and solidifying. The prior art also discloses apparatuses which melt the soap remnants directly in the mold. These apparatuses use molds that are removable from a housing containing a heating element, which may have benefits such as having the option to interchange different molds and to clean or replace molds separately from the device.

However, it is advantageous to have the mold integrally formed with the housing in that an integral design decreases the number of parts used for the apparatus, which in turn reduces the complexity of use for the user of the apparatus. Decreased complexity for the user leads to greater assurance the device will operate as intended, because, for example, the mold will not be improperly positioned during operation. Additional features not provided in existing devices which melt soap directly in the mold, either individually or in combination, include a battery for operation while disconnected to an external power source, a power cord for charging the battery, and a rectangular housing.

### (h) BRIEF SUMMARY OF THE INVENTION

An embodiment of the disclosure meets the needs presented above by generally comprising a housing with a bottom wall, a top wall, and a perimeter wall, the perimeter wall being coupled to and extending between the bottom wall and the top wall. The housing defines an interior space bounded by each of the bottom wall, the top wall, and the perimeter wall. A mold is coupled to the top wall and extends downwardly into the interior space. The mold has an open top and is integral with the top wall of the housing. A heating element is coupled to the mold and is positioned in the interior space. The heating element is also positioned such that the heating element heats the mold when the heating element is activated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a soap recycling apparatus according to an embodiment of the disclosure.

FIG. 2 is a rear view of an embodiment of the disclosure.

FIG. 3 is a side view of an embodiment of the disclosure.

FIG. 4 is a top front side perspective view of an embodiment of the disclosure.

FIG. 5 is a cross-sectional view of an embodiment of the disclosure taken from Arrows 5-5 in FIG. 3.

FIG. 6 is a cross-sectional view of an embodiment of the disclosure taken from Arrows 6-6 in FIG. 3.

FIG. 7 is a perspective in-use view of an embodiment of the disclosure.

FIG. 8 is a front in-use view of an embodiment of the disclosure.

FIG. 9 is a block diagram of an embodiment of the disclosure.

### (j) DETAILED DESCRIPTION OF THE INVENTION

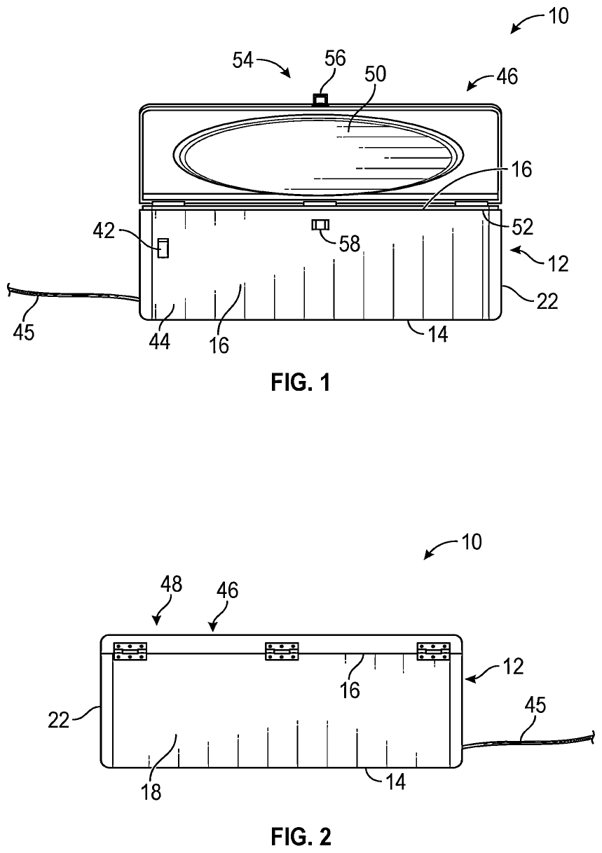

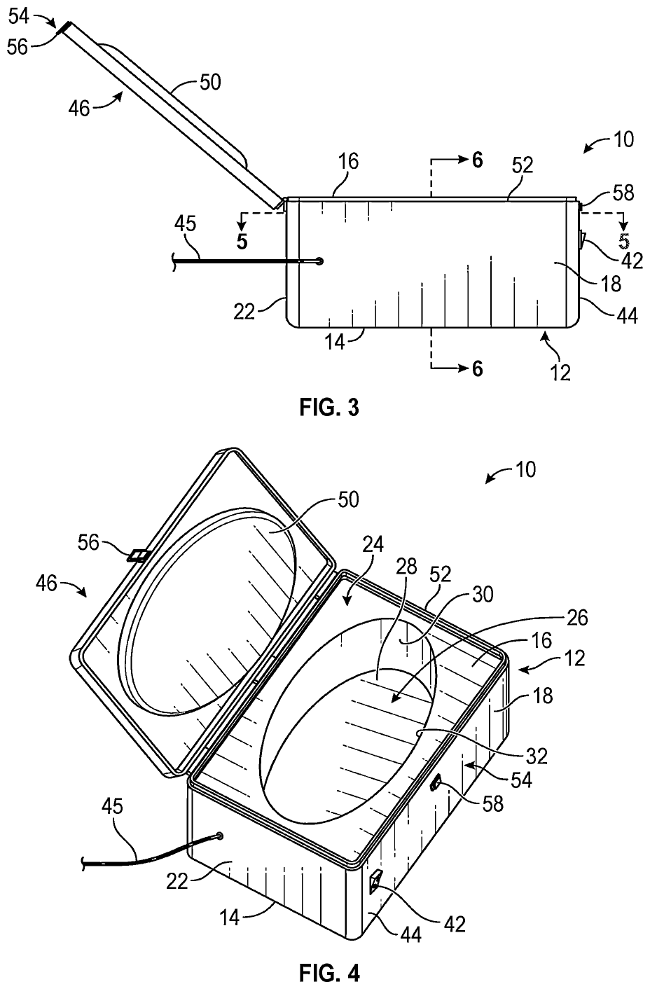

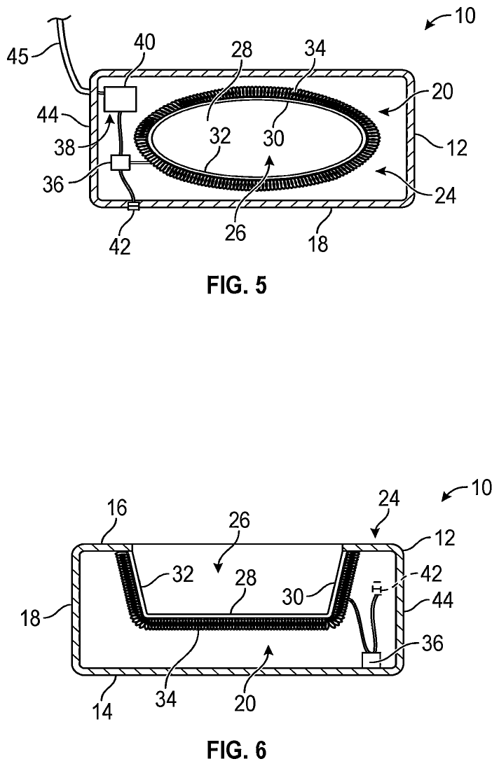

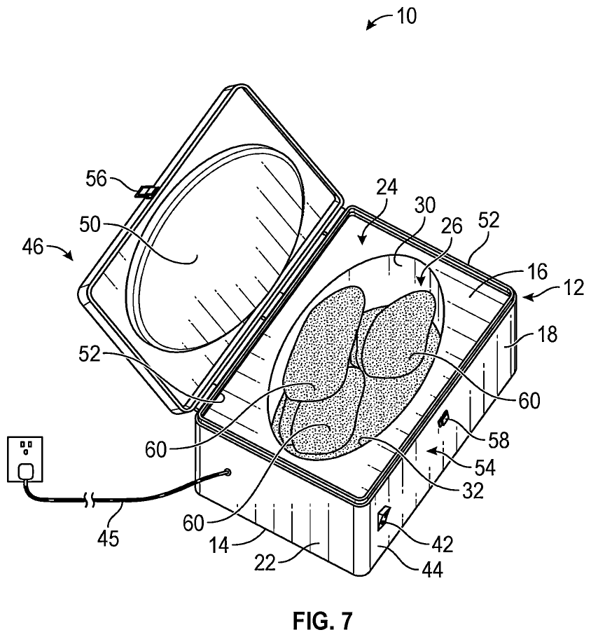

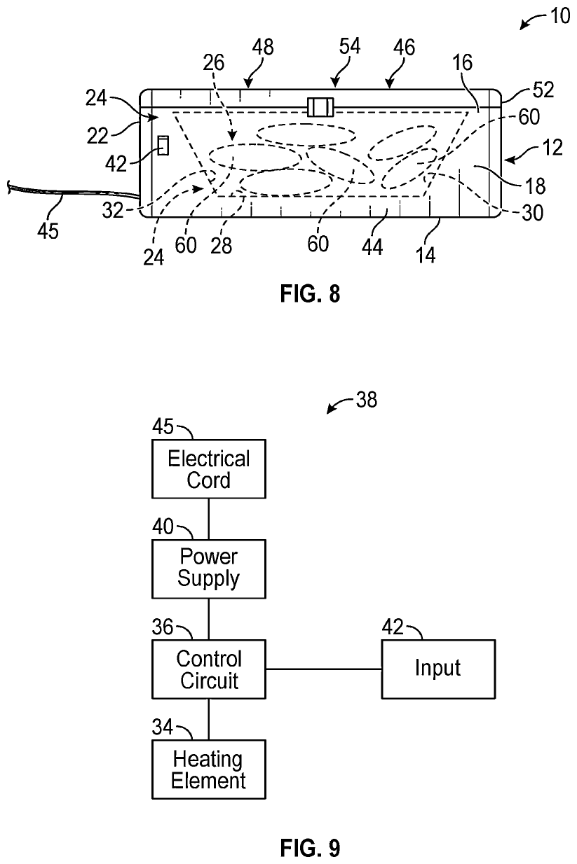

With reference now to the drawings, and in particular to FIGS. 1 through 9 thereof, a new soap recycling apparatus embodying the principles and concepts of an embodiment of the disclosure and generally designated by the reference numeral 10 will be described.

As best illustrated in FIGS. 1 through 9, the soap recycling apparatus 10 generally comprises a housing 12 with a bottom wall 14, a top wall 16, and a perimeter wall 18, in which the perimeter wall 18 is coupled to and extending between the bottom wall 14 and the top wall 16. The housing 12 defines an interior space 20 bounded by each of the bottom wall 14, the top wall 16, and the perimeter wall 18, and the perimeter wall 18 has a rectangular shape 22. A mold 24 is coupled to the top wall 16 and extends downwardly into the interior space 20. The mold 24 has an open top 26. The top wall 16 of the housing 12 and the mold 24 are integrally formed with each other. The mold 24 has a base wall 28 and a sidewall 30, and the sidewall 30 is coupled to and extends between the base wall 28 of the mold 24 and the top wall 16 of the housing 12. The sidewall 30 tapers from the top wall 16 of the housing 12 to the base wall 28 of the mold 24. The base wall 28 is planar, and the sidewall 30 has an elliptical shape 32. A heating element 34 is coupled to the mold 24 and is positioned in the interior space 20. The heating element 34 is positioned such that the heating element 34 heats the mold 24 when the heating element 34 is activated. The heating element 34 extends around the sidewall 30 and along the base wall 28.

A control circuit 36 is operatively coupled to the heating element 34. The control circuit 36 is also coupled to the housing 12 and is positioned within the interior space 20. A power supply 38 is electrically coupled to the control circuit 36, the power supply 38 comprising a battery 40. An input 42 for activating the heating element 34 is electrically coupled to the control circuit 36 and is mounted to an outer surface 44 of the housing 12. An electrical cord 45 is electrically coupled to the battery 40 and extends outwardly through the housing 12.

A lid 46 is positionable in a closed position 48 in which the lid 46 covers the open top 26 of the mold 24. The lid 46 has an insertion portion 50 which is complementary in shape to the open top 26 of the mold 24. The insertion portion 50 extends through the open top 26 of the mold 24 when the lid 46 is positioned in the closed position 48. The lid 46 is pivotally coupled to an outer edge 52 of the top wall 16 of the housing 12. A connector 54 is coupled to the lid 46 and the housing 12 for removably fastening the lid 46 to the housing 12 to secure the lid 46 is in the closed position 48. The connector 54 comprises a first mating member 56 and a second mating member 58. The first mating member 56 is coupled to the lid 46, and the second mating member 58 is coupled to the housing 12.

In use, bar soap remnants 60 are added to the mold 24. The input 42 is actuated to activate the heating element 34, which heats the mold 24 to melt the bar soap remnants 60 contained inside the mold 24. The bar soap remnants 60 take on the shape of the mold 24 to be reconstituted into a new bar of soap. The input 42 is actuated to deactivate the heating element 34, allowing the new bar of soap to cool and solidify. The lid 46 may be closed to secure the bar soap remnants 60 within the mold 24 as they are added. The lid 46 may also act as part of the mold 24 by engaging a top of the bar soap remnants 60 when the bar soap remnants 60 are melted such that the new bar of soap conforms to a bottom surface of the lid 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A soap recycling apparatus comprising:
a housing having a bottom wall, a top wall, and a perimeter wall, said perimeter wall being coupled to and extending between said bottom wall and said top wall, said housing defining an interior space bounded by each of said bottom wall, said top wall, and said perimeter wall;
a mold being coupled to said top wall and extending downwardly into said interior space, said mold having an open top, said mold being integral with said top wall of said housing; and
a heating element being coupled to said mold and being positioned in said interior space, said heating element being positioned such that said heating element heats said mold when said heating element is activated.

2. The apparatus of claim 1, wherein said perimeter wall has a rectangular shape.

3. The apparatus of claim 1, wherein said mold has a base wall and a sidewall, said sidewall being coupled to and extending between said base wall of said mold and said top wall of said housing, said sidewall tapering from said top wall of said housing to said base wall of said mold, said base wall being planar.

4. The apparatus of claim 3, wherein said sidewall has an elliptical shape.

5. The apparatus of claim 1, wherein said heating element extends around said sidewall and along said base wall.

6. The apparatus of claim 1, further comprising:
a control circuit being operatively coupled to said heating element, said control circuit being coupled to said housing and being positioned within said interior space; and
a power supply being electrically coupled to said control circuit.

7. The apparatus of claim 6, wherein said power supply comprises a battery.

8. The apparatus of claim 7, further comprising an electrical cord being electrically coupled to said battery, said electrical cord extending outwardly through said housing.

9. The apparatus of claim 1, further comprising:
a control circuit being operatively coupled to said heating element, said control circuit being coupled to said housing and being positioned within said interior space; and
an input for activating said heating element being electrically coupled to said control circuit.

10. The apparatus of claim 9, wherein said input is coupled to an outer surface of said housing.

11. The apparatus of claim 1, further comprising a lid being positionable in a closed position wherein said lid covers said open top of said mold.

12. The apparatus of claim 11, wherein said lid has an insertion portion being complementary in shape to said open top of said mold, said insertion portion extending through said open top of said mold to secure said lid is positioned in said closed position.

13. The apparatus of claim 11, wherein said lid is pivotally coupled to an outer edge of said top wall of said housing.

14. The apparatus of claim 11, further comprising a connector being coupled to said lid and said housing for removably fastening said lid to said housing to secure said lid is in said closed position, said connector comprising a first mating member and a second mating member, said first mating member being coupled to said lid, said second mating member being coupled to said housing.

15. A soap recycling apparatus comprising:
a housing having a bottom wall, a top wall, and a perimeter wall, said perimeter wall being coupled to and extending between said bottom wall and said top wall, said housing defining an interior space bounded by each of said bottom wall, said top wall, and said perimeter wall, said perimeter wall having a rectangular shape;
a mold being coupled to said top wall and extending downwardly into said interior space, said mold having an open top, said mold being integral with said top wall of said housing, said mold having a base wall and a sidewall, said sidewall being coupled to and extending between said base wall of said mold and said top wall of said housing, said sidewall tapering from said top wall of said housing to said base wall of said mold, said base wall being planar, said sidewall having an elliptical shape;
a heating element being coupled to said mold and being positioned in said interior space, said heating element being positioned such that said heating element heats said mold when said heating element is activated, said heating element extending around said sidewall and along said base wall;
a control circuit being operatively coupled to said heating element, said control circuit being coupled to said housing and being positioned within said interior space;
a power supply being electrically coupled to said control circuit, said power supply comprising a battery;
an input for activating said heating element being electrically coupled to said control circuit, said input being coupled to an outer surface of said housing;
an electrical cord being electrically coupled to said battery, said electrical cord extending outwardly through said housing;
a lid being positionable in a closed position wherein said lid covers said open top of said mold, said lid having an insertion portion being complementary in shape to said open top of said mold, said insertion portion extending through said open top of said mold when said lid is positioned in said closed position, said lid being pivotally coupled to an outer edge of said top wall of said housing; and
a connector being coupled to said lid and said housing for removably fastening said lid to said housing when said lid is in said closed position, said connector comprising a first mating member and a second mating member, said first mating member being coupled to said lid, said second mating member being coupled to said housing.
